(19) United States
(12) Patent Application Publication
(10) Pub. No.: US 2012/0203597 A1
(43) Pub. Date: Aug. 9, 2012

(54) METHOD AND APPARATUS TO ASSESS OPERATIONAL EXCELLENCE

(76) Inventors: Suman JAGDEV, Mumbai (IN); Saurabh BHATNAGAR, Gurgaon (IN); Bhudeep HATHI, Mumbai (IN); Nidhi GADIA, Mumbai (IN)

(21) Appl. No.: 13/024,182

(22) Filed: Feb. 9, 2011

(51) Int. Cl. G06Q 10/00

(52) U.S. Cl. 705/7.38

(57) ABSTRACT

A business tool is disclosed to assess the operational capability of an organization. A framework is provided for a user to provide information from various sources, including a particular industry, a particular function, competition and research. An assessment of actual and desired scores defining the competitive essence is made, within each capability of a function, to come up with a collective number per function based on intra-function weight. This is followed by allocation of inter-function weight. Calculations of desired and actual scores are performed for the organization. The variance is reverse scaled to calculate the number for operational excellence. Where the actual number lacks the desired number, business insights and improvement opportunities are identified along with key tools. Where the desired number trails the actual number, optimization opportunities are identified. A strategic manager is armed with tactical and strategic information to take the organization on a journey of continued success.

### FIELD

This invention relates generally to strategic management tools employed in business. In particular, it advances a model to objectively calculate and analyze the operational capability of an organization.

### BACKGROUND

A business entity is a conglomeration of various functional units run as an organization. Each of these functional units is specialized to handle one aspect of the business of the entity. These functional units may include, but are not restricted to, product development, research and development, finance, sales, marketing, human resources, legal, information and technology (IT) and operations.

A business entity usually differentiates itself by making, acquiring or selling products and services which are in some way unique. A business entity's operations convert its resources and assets into the entity's desired goods and services. The operations department of the entity also implements a business entity's business strategy. Operations management is the design, execution and control of the business entity's operations.

Operations management encompasses many functions. One of these functions is strategic planning. Strategic planning is the formal consideration of an organization's future direction. Strategic planning is also a business entity's process of defining strategy and direction. The strategic planning process involves making decisions on allocation of resources. In particular, it involves making decisions on allocation of capital and people. The allocation of resources enables the pursuit of a defined strategy. Various business planning techniques can be used for strategic planning, including Strengths, Weaknesses, Opportunities, and Threats (SWOT) analysis and Political, Economic, Social, and Technological (PEST) analysis, among others.

The fundamental purpose of a business entity is described in its mission statement. A mission defines the intended future state of the business entity. Strategy provides a framework to join the ends that the firm is striving for and the means to get there.

In order to determine where a business entity is going, strategic managers have to first know where the business entity stands. Next, strategic managers then have to determine where the business entity should go and how it will get there. In order to know where the business entity stands, the state of the business entity has to be evaluated in terms of each of its functional units. Each functional unit has to be first assessed on its own effectiveness. Then, functional units, as a group, have to be assessed on their ability to communicate with each other and with external entities.

The functional units are tied to each other through the function of operations. Through operations, the business entity leverages the power of each of its functional units to deliver goods and services to the customer. In the end, the combined operations of the company is the money making process of the company. The more competitive, technologically savvy and effective a business entity's operations are, the more money it makes. A business entity's operations, therefore, are critical to its bottom line.

Operations are a key differentiator between successful and unsuccessful businesses. An excellent business entity almost universally excels in its operations. Operational excellence is achieved when a business is conducted so as to improve quality, obtain higher profits, achieve faster turnaround and reduce overhead. It invariably involves teamwork, problem solving and leadership resulting in continuous improvements throughout the organization. Good customer service, empowerment of employees and optimization of existing activities also help the organization achieve continuous improvement. Operational excellence drives performance levels that change the company's competitive position in the marketplace. Due to its impact on the bottom line, operational excellence is not only highly desired in a business entity, it is imperative for its very survival over the long term.

Businesses employ several tools to achieve or to measure operational excellence. These include Footprint Rationalization, Premier Resource Management and Six Sigma™, among others. Most of these programs and tools are first generational and have been so universally adopted that they do not differentiate a business entity from its competition any more. Some of these tools are also manufacturing centric. Most of the available tools are standalone one function tools. They do not gauge the organizational health fully. For a thorough evaluation of an organization's health, the method to measure has to be comprehensive. The method used also has to provide function by function information. Such information enables identification of areas where the desired state is exceeded or achieved along with areas where improvements have to be made.

Most operation excellence measurement tools are functionally limited. They lack comprehension in that they measure one function well, but lack a holistic approach. The tools are also limited by silo syndrome. An organization suffers from silo syndrome where each of its department or function interacts primarily within a “silo” or an “island” rather than with other groups across the organization. Marketing, for example, may develop its own culture and have difficulty interacting with other functions such as engineering or sales. In an organization, silo syndrome leads to suboptimal decision-making, redundancy and detached thinking. Silo syndrome, similarly restricts the quality of tool development for cross-functional organizational evaluation. Available tools do not explicitly consider the core competitive strength (competitive essence) of the firm while diagnosing and making recommendations on operational excellence. Most of the available tools are not function agnostic or industry agnostic. It is not possible to use the tools across industries or functions without virtually rewriting the tool.

### SUMMARY

A capability assessment model tool is described to aid managers of organizations in the area of strategic planning, and thereby help achieve operational excellence. In one embodiment of the present invention, the tool assesses a business operation along the dimensions of structure and execution. Using leading industry and functional practices, detailed assessment capabilities across all organization functions on structure and execution are provided. The tool is capable of leveraging external information for the assessment. Detailed graphs are provided to reflect simultaneously the actual and desired state vis-a-vis each function of the organization. More weight is accorded to functions that constitute an organization's competitive essence. To differentiate itself, these are the functions that an organization does best. Such according of weight makes the assessment relevant to critical elements like retention of competitive advantage. In one embodiment of the present invention, the tool provides a single number as the “operational excellence index.” The variance between maturity of firm across functions which define its competitive essence and actual maturity of capabilities is a key driver for the calculation of the “operational excellence index.”

In one embodiment of the present invention, the tool is both industry and function agnostic. It can be customized for a particular industry or function with manageable change. The tool provides key insights for improvement opportunities across all functions of the business entity. For a particular function and industry, the tool also provides mechanisms to leverage research and functional expertise. Strategic managers can use the information and organization's health metrics to provide quick fixes and also to implement long term changes. The tool offers decision enablers to identify key areas. This enables them to react tactically and strategically for improvement in operations of a business entity.

In one embodiment of the present invention, a method, apparatus and software is disclosed to assess an organization. Intra-function and inter-function weight based variance is calculated between actual and desired scores to identify excess and improvement areas.

### BRIEF DESCRIPTION OF THE DRAWINGS

The accompanying drawings are incorporated in and form a part of this specification. The drawings illustrate embodiments. Together with the description, the drawings serve to explain the principles of the embodiments.

FIG. 1 is a high level management consulting model of targeting and delivering value to organizations spread on industry, function and geography dimensions.

FIG. 2 is a diagram, focusing on “diagnose and explore” aspect to further divide it into several steps.

FIG. 3 shows the overarching nature of the capability assessment model that identifies areas and tools for improvements in various functions according to embodiments of the present invention.

FIG. 4 is a diagram showing the use, input and output model of the capability assessment model according to embodiments of the present invention.

FIG. 5 illustrates the user interface through the master menu which provides selection of each of the functions, summary report and options to customize the model based on research, industry and function according to embodiments of the present invention.

FIG. 6 illustrates the value proposition of the capability assessment model in terms of identifying deficiency areas, scope for improvement and opportunities, according to embodiments of the present invention.

FIG. 7 illustrates a summary report of the capability assessment model, showing actual and desired scores for various functions according to embodiments of the present invention.

FIG. 8 illustrates an operational excellence graph across a sample of nine functions for actual and desired scores, leading to business insights, opportunities and recommended tool suite, according to embodiments of the present invention.

FIG. 9 illustrates the steps involved in the calculation of the operational excellence model according to embodiments of the present invention.

FIG. 10 illustrates a sample calculation based on steps of FIG. 9 according to embodiments of the present invention.

FIG. 11 illustrates a computer system based use model according to embodiments of the present invention.

### DETAILED DESCRIPTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and functions have not been described in detail as not to unnecessarily obscure aspects of the embodiments of the present invention.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “assigning,” “calculating,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

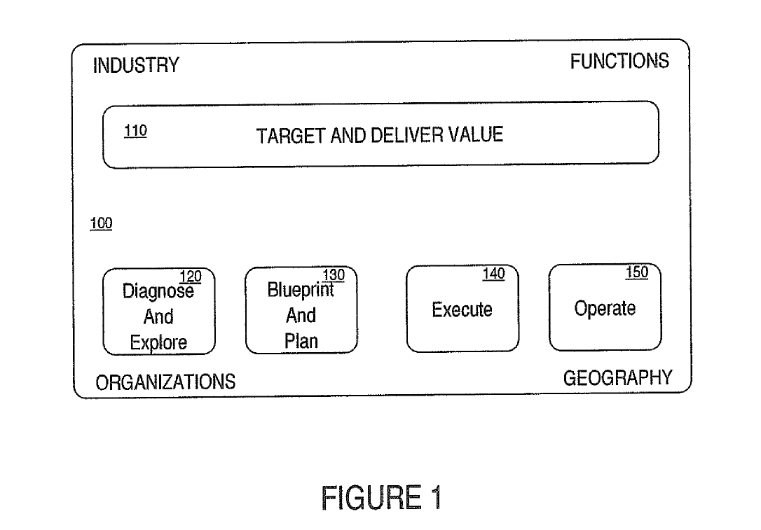

Referring to FIG. 1, organizations vary along the dimensions of industry, function and geography. In a management consulting model 100, organizations are targeted to deliver value 110. As a start of the process, the step of “diagnose and explore” 120 is undertaken. In an organizational context, this step involves the assessment of where an organization is, in terms of its competition, external and internal factors. In order to make appropriate changes and devise a road map for the organization to change, it has to be assessed on what is working well within the organization and what needs improvement. This is followed by the step of devising a map and plan 130 for change. In the next step, this devised plan is executed 140 and is brought into the day to day running of the organization through operations 150.

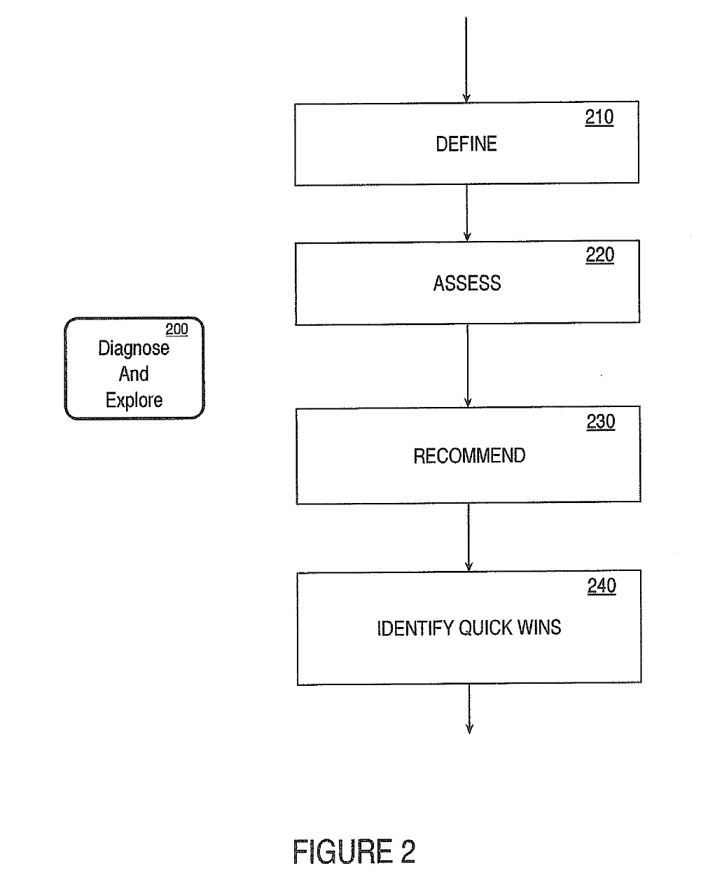

Referring to FIG. 2, the step of “diagnose and explore” 200 is broken up into four steps. These steps are “define” 210, “assess” 220, “recommend” 230 and “identification of quick wins” 240. In the “define” phase 210, the management consultant and the strategic managers of the organization define and agree on scope and objectives. Critical issues are identified and an initial premise is established on several hypotheses. Critical assets and capabilities are identified as well as the company's competitive essence is identified. The competitive essence or dominant vector is defined as a function or a set of functions that the organization does better internally than any of its competitors do in order to drive value for the customers. Competitive essence is the mechanism by which an organization best creates economic profit.

In the “assess” phase 220, the strategic manager and the management consultant confirm leading practices along the dimensions of structure and execution. In the structure dimension, maturity is assessed. As part of this inquiry, capability, location and governance issues are assessed. Similarly, in the execution dimension, people, process and technology issues are assessed. Finally, the organization's change capability is assessed. Such an assessment comprises use of strategic analysis tools as well as capability assessment tools.

The assessment phase is followed by the “recommend” phase 230, where the strategic manager and the management consultant develop change opportunities for both structure and execution dimensions. This phase also includes allocation of priority in the implementation of the change opportunities. A value realization plan and a journey is recommended to implement the change. In the “identification of quick wins” phase 240, short term low hanging fruits that would deliver results with immediate effect are identified and planned.

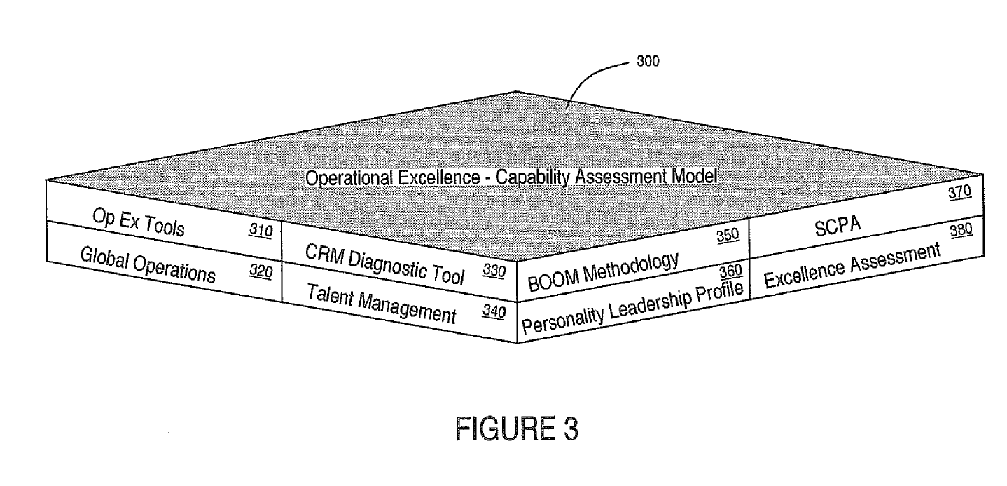

Referring to FIG. 3, the operational excellence capability assessment tool 300 is an overarching tool that evaluates the organization along the dimensions of structure and execution. The evaluation occurs for the whole organization as well as individually for its functions. Based on an assessment on the structure and execution dimension, critical areas of improvement are identified along with related tools 310 and methods. In one embodiment of the present invention, global operations may be evaluated 320. Similarly, in one embodiment, as an example, for issues with customer relationship management (CRM) 330, a CRM diagnostic tool similar to customer contact framework (CCF) may be used. Similarly, if issues are identified with the organization's supply chain, a supply chain performance assessment (SCPA) 370 tool or a supply chain operation target tool (SCOTT) may be used. Targeted solutions, similar to business oriented operating model (BOOM) tool 350 may be used. Personnel related tools similar to talent management 340, personality leadership profile 360 and excellence assessment 380 may be used.

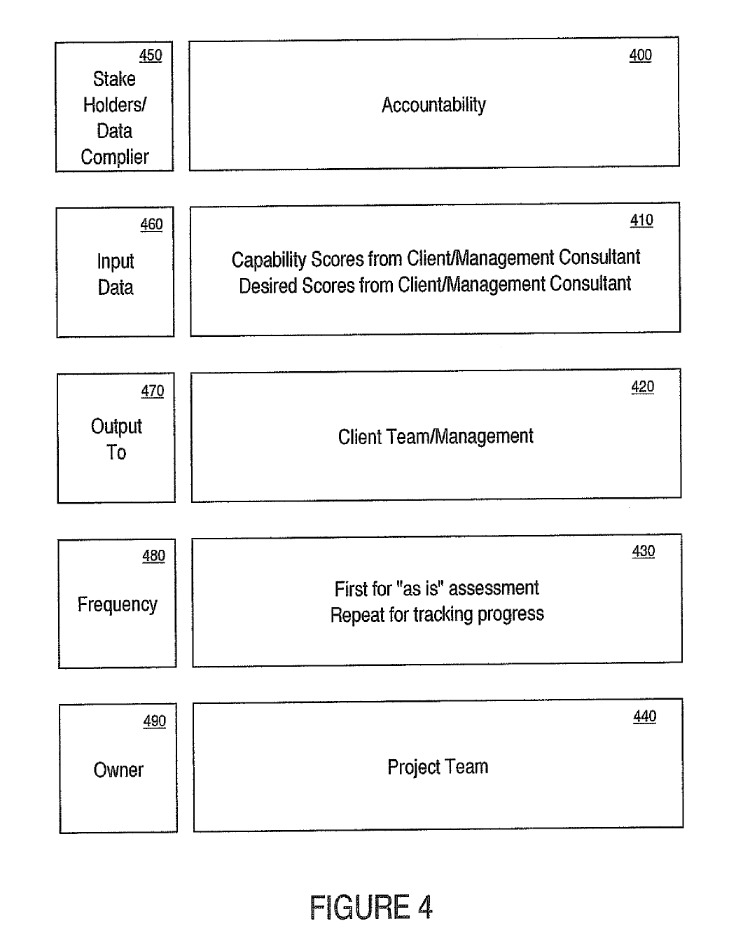

FIG. 4 presents a snapshot of the operational excellence capability assessment model in use. The stakeholders and data compilers 450 are the project managers who are accountable. The project managers, in one embodiment, may include the organization's strategic managers as well as representatives from the management consulting team 400. The base information and input data 460 includes, but is not restricted to, capability scores of the client. This includes actual assessment scores as well as scores desired by the client or by the management consulting team.

In one embodiment of the present invention, the scores that are desired are measured by inputting the industry parameters, competitive landscape and organization's competitive essence 410. The output of the use of the capability assessment model 470 is presented to an appropriate client team and to strategic managers 420. This may be used for internal review and reporting. The capability assessment tool is used several times 480. For the first time, it is used to perform an “as is” client assessment 430. Subsequently, it is used to track progress on the changes implemented along the structure and execution dimensions. The team to run the process 490 comprises team from strategic management and the management consultants 440. In one embodiment of the present invention, the tool may be run by a company's global operations department in consultation with management consultant.

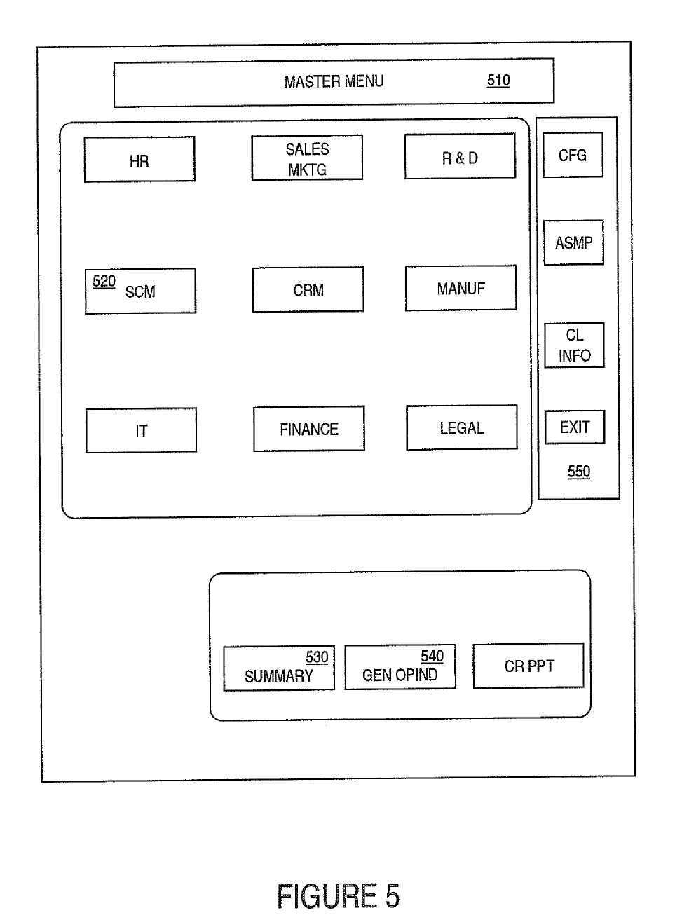

Referring to FIG. 5, in one embodiment of the present invention, the graphical user interface of the capability assessment tool for operational excellence is presented. The master menu 510 includes icons for all of the functions 520. A mini menu 550 is provided to change the model configurations and modeling assumptions based on research. Industry specific and function specific information is added to the model, which is otherwise industry agnostic as well as function agnostic. Being industry agnostic implies that the model is a general purpose tool that can be used for any industry. It has not been programmed for a specific industry. Similarly, being function agnostic means that the tool is not loaded with information related to a particular function of an organization. The main menu also provides a graphical icon, as an example, to provide a summary report 530 and to generate the operational index 540.

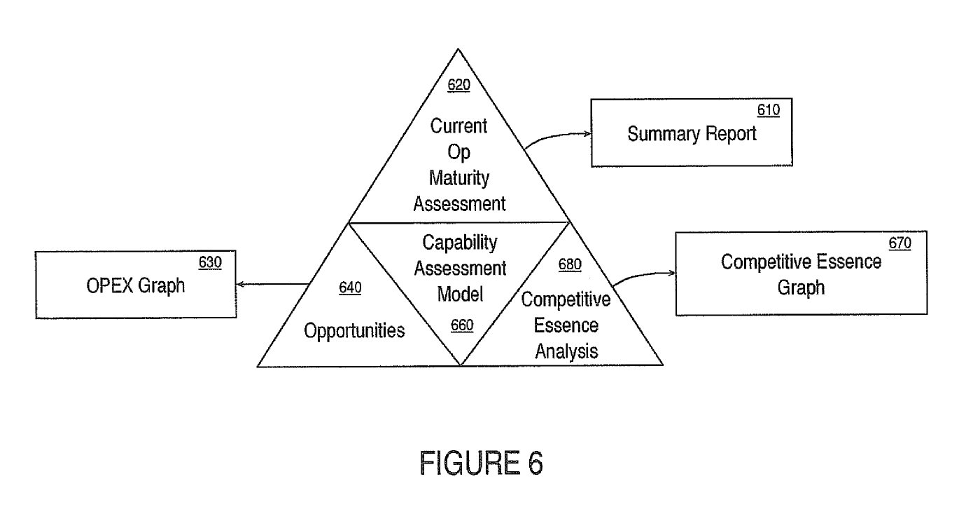

In one embodiment of the present invention, FIG. 6 presents a comprehensive value proposition offered by the capability assessment model 660. The capability assessment model evaluates where the organization stands with respect to the best practices of the industry. The tool first assesses the current operational maturity 620 along the dimensions of structure and execution. The output of this step comprises a summary report 610 which captures structural, execution and overall maturity for all the functions with respect to the leading practices for the function and industry.

This is followed by the second step of identifying the opportunities 640. The opportunities in process excellence and outsourcing are identified. The output from this step is an operational excellence graph 630. This graph indicates the existing gaps and opportunities for improvement across various business functions. The third step involves competitive essence analysis 680 which evaluates the organization's position with respect to competition. The output from this step is a competitive essence graph 670. This graph indicates if the organization is retaining its competitive advantage by strengthening the relevant support capabilities.

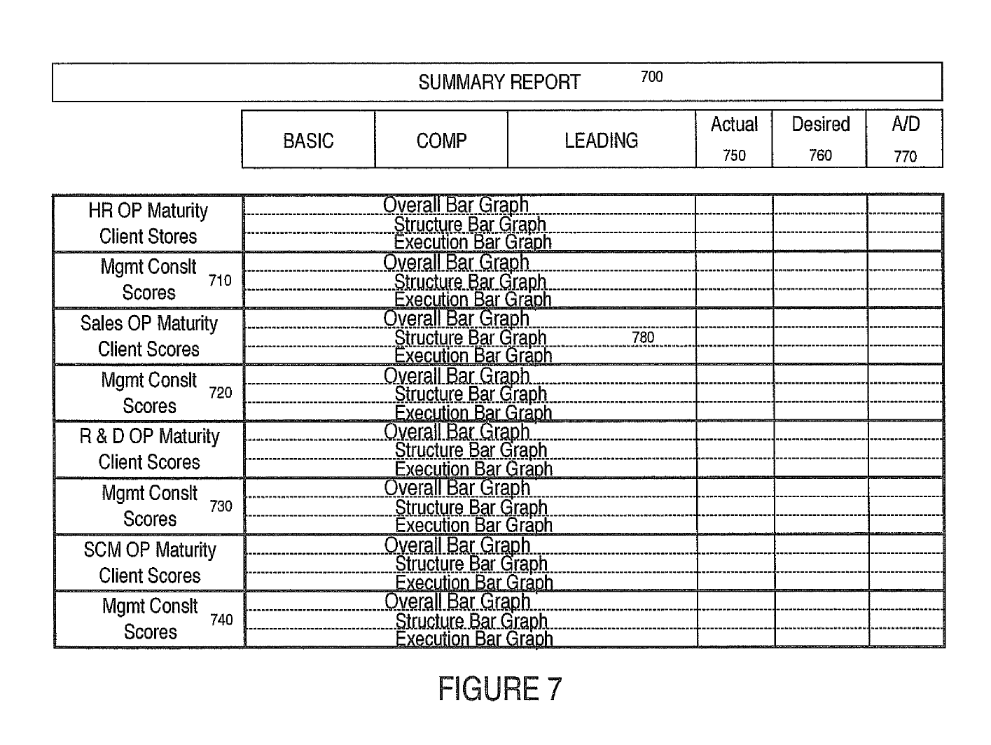

Referring now to FIG. 7, an embodiment of the capability assessment tool presents a summary report 700. Both actual 750 and desired 760 scores are displayed, along with a comparative percentage 770. The summary report indicates the extent to which the target is achieved. The actual scores are arrived at post assessment. In one embodiment, the actual and desired scores are represented in a color coded bar chart 780. As an example, the functions of human resources (HR) 710, sales and marketing 720, research and development 730 and supply chain management 740 are evaluated on the actual scores, the desired scores by the client and the desired scores by the management consultant. The evaluation is focused on overall operational maturity along the dimensions of structure and execution. Each function is also given a comprehensive grade. These grades or levels of maturity are reflected as being basic, competitive or leading. Such a grading provides an immediate snapshot of improvement areas as well as excess areas.

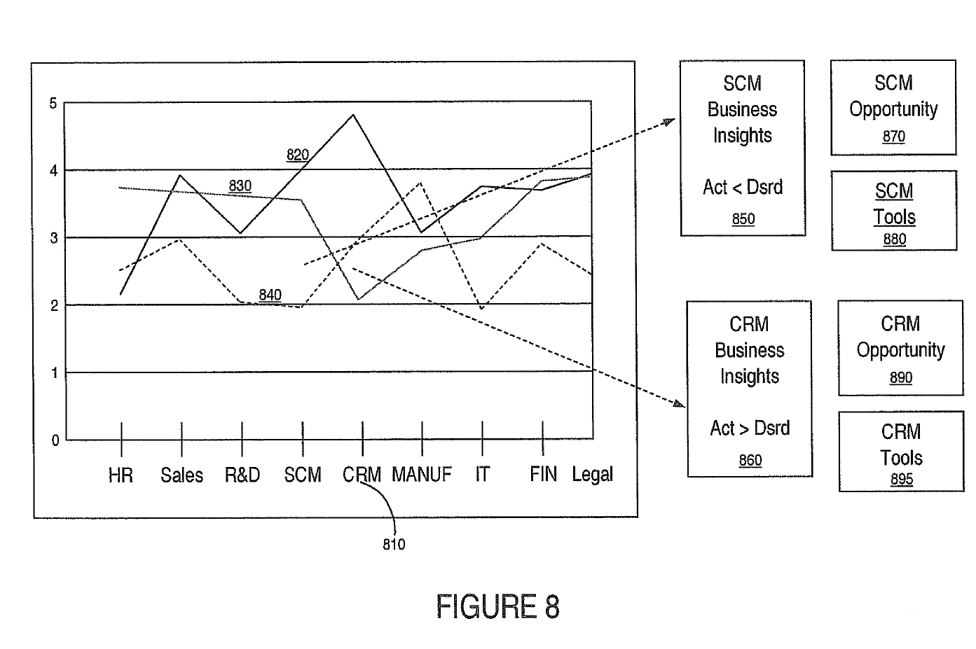

FIG. 8 shows the ability of the tool to consolidate the per function information collected, into an operational index. The results are graphically displayed from a scale from zero to five for all of the evaluated functions 810. As an example, human resources, sales and marketing, research and development, supply chain management, customer relationship management, manufacturing, information and technology, finance and legal 810 are displayed in FIG. 8. The graphs are point representations for each of the functions and are connected to show the function by function trend. The actual structure and execution graph for each function is shown by 840. The desired structure and execution graph for each of the function from a client's perspective is shown by 820. The desired structure and the execution graph from a management consultant's point of view is shown by 830 and is the competitive essence of the firm. The management consultant has wider visibility into the function and industry based on its position and research. Therefore, this view provides an objective assessment to the strategic managers who, at times, are focused at looking inwards.

The supply chain management's actual evaluation is presented as an example, where the actual values are below the desired values 850. The lower score provides business insights. These insights include an opportunity for process excellence, performance improvement and additional investments. These are the business insights gained. The business opportunities 870 presented include function specific and industry specific opportunities. As an example, for supply chain management, procurement and sourcing strategy may be focused on and manufacturing or design aspects may be targeted. New planning for the supply chain may take place, as well as fulfillment process may be integrated 870. Related to the domain area of supply chain, specific tools available in the area of supply chain including SCPA, BOOM or SCOTT may be used from a suite of tools 880.

As an example, a function where the actual numbers are better than the desired numbers is highlighted through the function of customer relationship management 860. The actual index is at 3.0, whereas one desired by the management consultant is 2.0. Where the actual value exceeds the desired value, the strategic manager is presented with opportunities for shared services and outsourcing. Overinvestment is indicated, which provides an opportunity for optimum resource allocation 860. The business opportunities presented to the strategic manager include marketing optimization, increased customer satisfaction, enablement of customers and integration of channels 890. In the area of customer relationship management, the tools presented are a sales technology enablement tool, customer contact framework (CCF) and customer interaction center diagnostic tool 895. The capability assessment model, in action, in this example, shows an improvement area of supply chain management. The capability assessment model also offers specific business opportunities and tools to effectuate the change. In addition, the tool also shows an overcommitted area in customer relationship management where reallocation of resources is an option for the strategic manager.

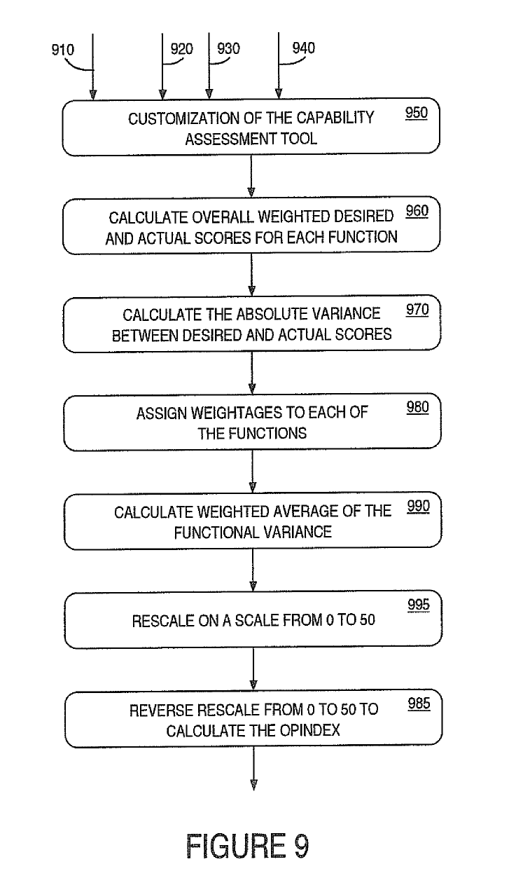

FIG. 9 presents the steps involved in the calculation of the overall operational index of the organization according to embodiments of the present invention. Several inputs are provided to the process. In one embodiment of the present invention, the first input is the generic version of the capability assessment model 910. The second input provided to the process is the industry specific information to the tool, which is otherwise industry agnostic 920. The third set of input is related to the particular function being evaluated 930. Information specific to a particular function is provided, which includes a list of applicable business insights and business tools from a suite related to the function. The final input includes research done by the management consultant, representing external factors and objectivity 940. This may include information compiled on the competition, the appropriate quarterly or annual reports on financial data and company performance, the analysts' perspective on the client as well as the competition, the analysts' or other expert's outlook on the function and the industry. This may also include the scope of the business climate, effect of globalization and fluctuations in world currencies and markets.

In one embodiment of the present invention, the capability assessment tool uses each of the above inputs to its generic framework to provide a customized tool, fitting uniquely, with the client's function and organization 950. Once a customized version of the tool is available, the tool assigns weights to each facet of the function based on the industry of interest. A manufacturer of commodity goods, for example, will focus heavily on its supply chain efficacy and so this function will be accorded a high weight. In step 960, based on the accorded weights to each facet of the function, overall weighted desired and actual scores are calculated for each function.

In one embodiment of the present invention, the weights may be accorded based on either one or any combination of competition, industry and the competitive essence of the organization. The process of weight allocation is followed by the step where absolute values of the variances between actual and desired scores are calculated 970. In step 980, after having allocated weights to each facet of the function in step 960, each of the macro functions are assigned weights in step 980. This is followed by a calculation of the weighted average of the functional variance in step 990. Following this is step 995, where a rescaling is done on the overall index from a scale of 0 to 50. It has to be noted by those skilled in the art that the operational excellence index is inversely related to the variance between the actual and desired values for each function. To reflect this inverse relationship, in step 985, the current index scaled to 50 index is rescaled in a reverse way. In one embodiment of the present invention, this leads to a single number, called the operational index of the organization.

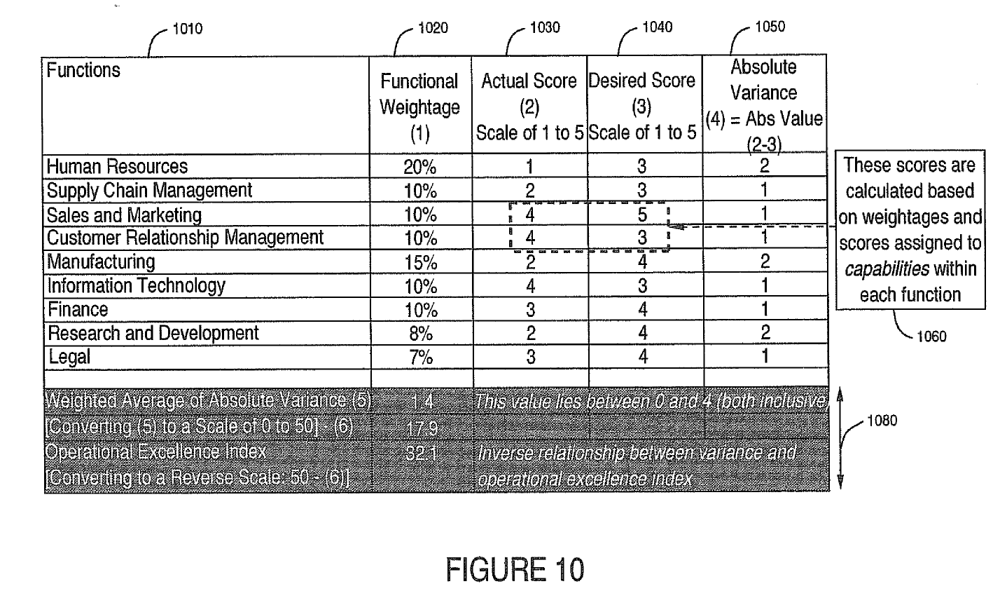

Referring to FIG. 10, the operational index is calculated for an organization as an illustration. Column 1010 itemizes the functions, which are the same set of nine functions identified earlier. The functional weight is identified in column 1020. In this example, human resources is accorded 20% weight, supply chain management 10%, sales and marketing 10%, customer relationship management 10%, manufacturing 15%, information and technology (IT) 10%, finance 10%, research and development (R&D) 8% and legal 7%. Actual scores on a scale of 1 to 5 are itemized in column 1030. These scores are calculated based on weights and scores assigned to capabilities within each function. Similarly, in one embodiment of the present invention, column 1040 holds similar information for desired scores on a scale of 1 to 5. Column 1050 holds the absolute variance, which is the absolute value of the difference between actual and desired scores.

In 1080, row 1, the weighted average of absolute variance is calculated. Referring to column 1050 and column 1020, the weighted average is calculated by multiplying the two columns row by row, performing the addition and dividing by 100 for each of the nine functions. This calculation is summarized as (20*2/100+10*1/100+10*1/100+10*1/100+15*2/100+10*1/100+10*1/100+8*2/100+7*1/100)=1.43, which is rounded to 1.4.

In 1080, row 2 of FIG. 10, the above index, on a scale from 0 to 4 is converted to a scale from 0 to 50. In one embodiment of the present invention, for this conversion, a direct linear conversion method is used. The number on the current scale is normalized through division with the current range (0 to 4, 4) and then, new rescaled value is obtained by multiplication with the new range (0 to 50, 50). Accordingly, the index on the scale from 0 to 50 is 1.43*50/4=17.875 or 17.9.

There exists an inverse relationship between operational excellence index and the variance between actual and desired scores as calculated. In one embodiment of the present invention, to honor this inverse relationship between the “operational excellence index” and the difference between the actual and the desired scores as measured by the absolute value of the variance, a reverse scaling is undertaken. If the index is high on variance, it has to be low on the reverse scale and vice versa. In one embodiment, this reverse scaling is linear, calculated as a subtraction of 50 and the calculated index in 1080, row 2. In this exemplary calculation, this therefore is (50−17.9) or 32.1 as shown in 1080, row 3.

It must be noted by those skilled in the art that whereas an exemplary calculation of a single number representing the operational excellence has been illustrated, it is but one embodiment of the invention. An embodiment of the present invention embodies other methods of assigning weights, calculating averages, calculating scaling and rescaling. Whereas linear modeling has been used, other models may be used in a different industry or function context.

In an embodiment of the present invention, mechanisms may be placed that automatically update the calculations to specific changes to inputs, either model specific, industry specific, function specific or based on research. Specific change of circumstances may be specified by the user to trigger the recalculation. In another embodiment, the functionally SILO calculations may be smoothened out by careful assignment of weight process within a function and across a function. In one embodiment, the weights may be determined by detailed mathematical modeling and simulations of the dynamics of an organization.

Whereas an embodiment of the present invention proposes an industry agnostic and function agnostic tool, which is then customized to a client, an embodiment of the invention may include a base version of the tool targeted to a particular industry and functions that are traditionally part thereof. This is suitable for industry that has matured and has a number of large players where a dedicated tool may add value.

In another embodiment of the invention, the capability assessment model may also be used to assess the effectiveness of the changes. Whereas an embodiment of the present invention uses the capability assessment model in diagnostic phase, the capability assessment model can also be used to evaluate the recommended change programs. Based on the initial diagnostics, the strategic manager may implement process efficiencies, cost reduction and performance improvement. The effect of these programs, in one embodiment of the invention, may be evaluated by reusing the capability assessment tool. It is expected that if the recommended changes are effective, the variance between desired and actual scores along all of the functions will tend to converge. The maturity level of capabilities reflected by the actual scores will be aligned to the desired scores at the end of the completion of the process of change triggered by the initial diagnostics.

In another embodiment of the invention, the particular aspect of operations of an organization may be broken on separately achievable macro goals, rather than on each of the function. In one embodiment, the aspect of operation may be assessed on use of capital (capital effectiveness), asset productivity and risk management. The underlying mechanisms of embodiments of the present invention may be deployed to evaluate and assess each of the above aspects of operations.

In an embodiment of the present invention, the capability assessment model may be targeted to the area of outsourcing. Operational excellence is essential to a company's ability to drive greater business value through outsourcing. The capability assessment model may be used, for example, as a common tool by which companies and their outsourcing providers can work together toward continuously improving their business functions and services. Similar to a full diagnostic assessment, what is working well and what could be done better may be assessed for the joint work between companies and their outsourcing partners. Strategies may be evaluated on combining common functions to lower cost and improve business performance. In this embodiment, the capability assessment tool is used to evaluate the increasingly critical outsourcing area of operations. A capability assessment model, in this embodiment, can be used prior to making the outsourcing decision as well as after some functions of the company have been outsourced. This may be a critical tool in today's global economy.

In another embodiment, the capability assessment model may be used in a merger and acquisition (M & A) analysis. In a merger and acquisition, generally, two or more business entities are combined. In an acquisition, one of the entities is subsumed into the other. In a merger, on the other hand, there is a combination of entities, generally to form a new entity. In either a merger or an acquisition, the capability assessment tool can be deployed to first assess individual companies. By performing both a whole organization evaluation, as well as a function by function evaluation, the exceeding and lagging areas may be identified for each of the entities. As an evaluation of projected synergy, a strategic manager may evaluate the profile of exceeding areas and lagging areas in both entities.

Generally, when both entities are strong in their respective competitive essence, which are non-overlapping, a good fit for merger and acquisition may be projected. Similarly, a good fit on a merger or acquisition may be projected where the lagging and excess areas complement each other in the two business entities about to be merged. As an example, a business entity may be very strong in product development but may be lagging in the area of customer relationship management. The second business unit may be strong in customer relationship management, but weak in product development. In such a case, a good fit is achieved between the two business entities when they merge, as the two will complement each other's strengths and weaknesses. In the capability assessment model, this is reflected as a match on some functions between the actual scores of one business entity and desired scores of another business entity. Importantly, an embodiment of the present invention can be used for M & A analysis in the phase before the joining of the entities to evaluate a fit, as well as later, to measure the workings of the combined entity.

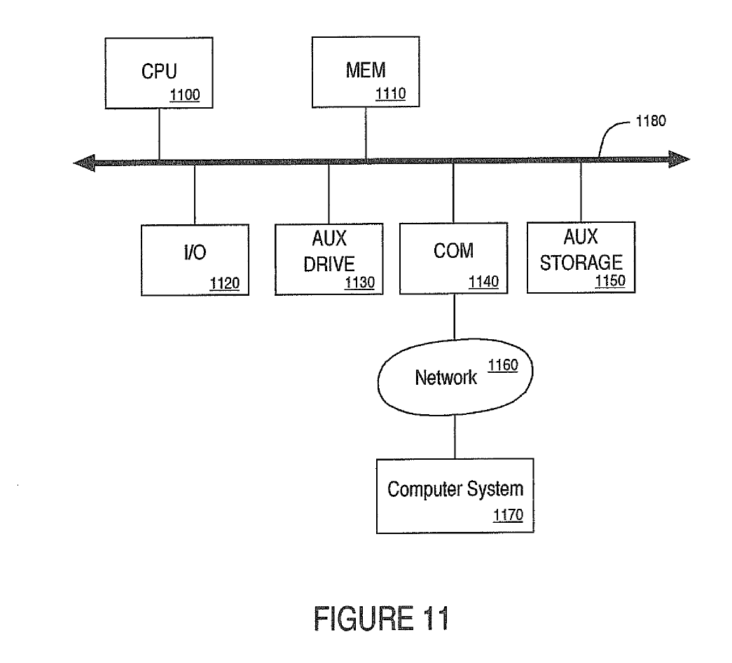

FIG. 11 presents a typical use model of an embodiment of the present invention. A typical computer system comprises CPU 1100, a memory 1110 and an input output system 1120. These components are connected to each other through a bus 1180. Also connected to this bus 1180 are an auxiliary storage 1150, a communication port 1140 and an auxiliary drive 1130. The communication port 1140 connects the computer system to a computer network 1160. Such a computer network 1160 is connected, as an embodiment of the present invention, to another computer system 1170.

Through an auxiliary drive 1130, a computer program holding instructions to execute a capability assessment model may be installed in the computer with CPU 1100. This may employ the use of removable media. Through this installation process, the computer program, from the auxiliary drive, is transferred by appropriate mechanisms to the computer system's memory 1110. User interfaces according to embodiments of the present invention are made available to the user including a graphical user interface. Using the user interface, the program holding the capability assessment model is executed and it provides outputs on the computer system consistent with embodiments of the present invention. The computer system with CPU 1100 may be located at the management consultant's premises or at the client's premises.

In another embodiment, a computer system 1170 may be connected to computer system 1100 through a communication port 1140 via a computer network 1160. The computer system may be located at the client's premises. Through computer system 1170, the client may access the program from memory 1110 via a direct memory access operation and load it into its own memory. The client may then execute the program using its own CPU. In the alternate, computer system 1170 may act as a client with the capability assessment model running on the management consultant's machine with CPU 1100. The results may be displayed by computer system 1170 in response to user interface running on computer system 1170.

In the foregoing specification, embodiments have been described with reference to numerous specific details that may vary from implementation to implementation. Thus, the sole and exclusive indicator of what is the invention, and is intended by the applicant to be the invention, is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. An organization assessment method comprising:
assigning, in a capability assessment model, a first set of weights to a plurality of capabilities for each function of a plurality of functions in the organization, wherein the first set of weights relates to the organization's industry, competitive essence and competition;
calculating a first variance comprising a variance between a desired and an actual score for the plurality of capabilities in the capability assessment model;
calculating a second variance comprising a variance for the plurality of functions as a weighted average, using the first set of weights and the variance of the plurality of capabilities in the capability assessment model;
assigning, in the capability assessment model, a second set of weights to a plurality of functions of the organization, wherein the second set of weights relates to the organization's industry, competitive essence and competition;
calculating a third variance comprising a variance for the organization as a weighted average, using the second set of weights and the variance of the plurality of functions in the capability assessment model; and
relating the third variance of the organization as a measure of excellence in the capability assessment model,
wherein the capability assessment model is customized for the organization,
further wherein, the capability assessment model is implemented as computer readable software and executed in a computing device.

2. The method of claim 1 wherein the assessment of the organization corresponds to the operations of the organization.

3. The method of claim 1 wherein the functions comprise at least one of human resources (HR), information technology (IT) legal, manufacturing, supply chain management, research and development (R & D), sales and marketing, customer relationship management (CRM), and finance.

4. The method of claim 2 wherein the operation of the organization comprises at least one of a dimension of execution and a dimension of structure.

5. The method of claim 1, further comprising use of the variance between the actual score and the desired score of the function for accessing at least one of a set of business tools, a set of business insights and a set of business opportunities.

6. The method of claim 1, wherein:
a range of the actual or the desired scores is from 0 to 5.

7. A system comprising a processor, a bus and a memory, wherein the
memory comprises instructions that when executed implement a method of organization assessment, the method comprising:
assigning, in a capability assessment model, a first set of weights to a plurality of capabilities of a function of the organization, wherein the first set of weights relates to the organization's industry, competitive essence and competition;
calculating a first variance comprising a variance between a desired and an actual score for the plurality of capabilities in the capability assessment model;
calculating a variance for the function as a weighted average, using the first set of weights and the variance of a plurality of capabilities;
assigning in the capability assessment model, a second set of weights to a plurality of functions of the organization, wherein the second set of weights relates to the organization's industry, competitive essence and competition;
calculating a third variance comprising a variance for the organization as a weighted average, using the second set of weights and the variance of the plurality of functions in the capability assessment model; and
relating the third variance of the organization as a measure of excellence in the capability assessment model,
wherein the capability assessment model is customized for the organization.

8. The system of claim 7 wherein the assessment of the organization corresponds to the operations of the organization.

9. The system of claim 7 wherein the functions comprise at least one of human resources (HR), information technology (IT) legal, manufacturing, supply chain management, research and development, sales and marketing, customer relationship management (CRM), and finance.

10. The system of claim 8 wherein the operation of the organization comprises at least one of a dimension of execution and a dimension of structure.

11. The system of claim 7, further comprising use of variance between the actual score and the desired score of the function for accessing at least one of a set of business tools, a set of business insights and a set of business opportunities.

12. The system of claim 7, wherein:
the range of the actual or the desired scores is from 0 to 5.

13. A non transitory computer readable memory comprising programmed instructions that when executed implement a method of organization assessment, the programmed instructions comprising:
instructions to assign, in a capability assessment model, a first set of weights to a plurality of capabilities for each function of a plurality of functions in the organization, wherein the first set of weights relates to the organization's industry, competitive essence and competition;
instructions to calculate a first variance comprising a variance between a desired and an actual score for the plurality of capabilities in the capability assessment model;
instructions to calculate a second variance comprising a variance for the plurality of functions as a weighted average, using the first set of weights and the variance of the plurality of capabilities in the capability assessment mode;
instructions to assign, in the capability assessment model, a second set of weights to a plurality of functions of the organization, wherein the second set of weights relates to the organization's industry, competitive essence and competition;
instructions to calculate a third variance comprising a variance for the organization as a weighted average, using the second set of weights and the variance of the plurality of functions in the capability assessment model; and
instructions to relate the third variance of the organization as a measure of excellence in the capability assessment model,
wherein the capability assessment model is customized for the organization.

14. The non transitory computer readable memory of claim 13 wherein the assessment of the organization corresponds to the operations of the organization.

15. The non transitory computer readable memory of claim 13 wherein the plurality of functions comprises at least one of human resources (HR), information technology (IT), legal, manufacturing, supply chain management, research and development, sales and marketing, customer relationship management (CRM), and finance.

16. The non transitory computer readable memory of claim 14 wherein the operation of the organization comprises at least one of a dimension of execution and a dimension of structure.

17. The non transitory computer readable memory of claim 13, further comprising instructions to use the variance between the actual score and the desired score of the function to access at least one of a set of business tools, a set of business insights and a set of business opportunities.

18. The non transitory computer readable memory of claim 13, wherein:
a range of the actual or the desired score is from 0 to 5.

19. The method according to claim 1, wherein a range of the measure of excellence is from 0 to 50.

20. The method according to claim 1, wherein a relation between the variance and the measure of excellence is linear.

21. The system according to claim 7, wherein the range of the measure of excellence is from 0 to 50.

22. The system according to claim 7, wherein the relation between the variance and the measure of excellence is linear.

23. The non-transitory computer readable memory according to claim 13, wherein a range of the measure of excellence is from 0 to 50.

24. The non-transitory computer readable memory according to claim 13, wherein a relation between the variance and the measure of excellence is linear.
